(19) United States
(12) Patent Application Publication
(10) Pub. No.: US 2003/0017434 A1
(43) Pub. Date: Jan. 23, 2003

(54) Root canal instrument set

(76) Inventors: Frank Hagemann, Lemgo (DE); Bernd Otto, Kalletal (DE); Michael Kullmer, Lemgo (DE); Karl-Heinz Danger, Lemgo (DE)

Correspondence Address: Caroline G. Chicoine, Thompson Coburn LLP, One US Bank Plaza, Suite 3500, St. Louis, MO, 63101-9928, US

(21) Appl. No.: 10/202,683

(22) Filed: Jul. 23, 2002

(30) Foreign Application Priority Data
Jul. 23, 2001 (DE) 101 35 820.2
Jul. 23, 2001 (DE) 101 35 821.0

(51) Int. Cl. A61C 5/02

(52) U.S. Cl. 433/102

(57) ABSTRACT

The invention relates to a root canal instrument set comprising at least two root canal instruments, each root canal instrument being provided with a collar having a shaft end at one end and a working part including at least one cutting edge on the other end, the working part being shaped conically or crowned, wherein the cone angle of the working parts decrease from the preceding root canal instrument to the subsequent root canal instrument and the working part of the respectively preceding root canal instrument has a larger diameter than the working part of the respectively subsequent root canal instrument. Alternatively, the radii of the crowned working parts may increase from the preceding root canal instrument to the subsequent root canal instrument, and the working part of the preceding root canal instrument may have a larger diameter than the working part of the subsequent root canal instrument.

### BACKGROUND OF THE INVENTION

The present invention relates to root canal surgery and in particular, to a root canal instrument set for use in root canal surgery.

Several different tools have been developed for use in connection with root canal surgery. There are generally two different ways in which to operate on the root canal. One way involves starting with a relatively thin tool, and then following with a root canal instrument having a thicker diameter. The root canal is thus widened in its diameter step by step towards its free end. The other way of proceeding, also known as crown-down preparation, starts with a tool of larger diameter, by which the upper, outer portion of the root canal is processed, and then following with an instrument having a decreasing diameter to allow for a more extensive, far reaching processing of the root canal.

Many of existing root canal instruments have the drawback that they do not result in optimum preparation results, that there exists a considerable danger of breakage and that it is not possible to follow the natural course of the root canal.

It is therefore an object of the present invention to provide a root canal instrument set of the type mentioned above, which is safe in its application and leads to excellent preparation results while being of a simple structure and producible simply and at low costs.

### BRIEF SUMMARY OF THE INVENTION

According to the invention, the object is solved by the features of the independent claims, the dependent claims showing further advantageous embodiments of the invention.

According to the invention, it is provided that the cone angle of the working parts decreases from a preceding root canal instrument to the subsequent root canal instrument, wherein the working part of the preceding root canal instrument has a larger diameter than the working part of the subsequent working part.

As an alternative, the invention also provides that the radii of the crowned working parts increase from the preceding root canal instrument to the subsequent root canal instrument and that the working part of the preceding root canal instrument has a larger diameter than the working part of the subsequent root canal instrument, while the length of the working parts is identical.

Thus, the inventive embodiment relates to a set of root canal instruments. According to the invention, it is provided that not only the diameter of the instruments, but also their cone angle decreases. In this way, it is possible to penetrate into the conical recess generated by the preceding instrument with the subsequent instrument and to increase the depth of preparation of the root canal in this way.

According to the invention, it is also provided that on the one hand the diameter of the instruments decreases and that on the other hand the radius of the crowned working parts increases. In this way, it is possible to penetrate into the recess generated by the preceding instrument with the subsequent instrument and to increase the depth of preparation of the root canal in this way.

The inventive embodiment results in a shortened length of the respective working part, in turn resulting in an ameliorated bending strength, compared to the standard instruments known from the state of the art.

According to the invention, it is provided that the working length of the preceding root canal instrument is smaller than the working length of the subsequent root canal instrument. By using the inventive root canal instruments, a root canal being processed in cone segments or in segments is obtained.

According to the invention, the design of the working part may occur in different ways. It is especially advantageous if the working part is provided with a helical edge. The working part can be of a two-edge type or a three-edge type. This means that one, two or three cutting edges may be provided.

In order to guarantee a simple handling of each root canal instrument and to ensure an optimum processing depth, it is especially advantageous if the working length of the root canal instrument resulting from the length of the collar portion plus the length of the working part increases from the preceding root canal instrument to the subsequent root canal instrument. The shaft of the root canal instrument is thus inserted into the drive equally in each case, the different processing depths result automatically from the different lengths of the root canal instruments.

As already mentioned, the invention provides that not only the lengths of the root canal instruments increase within the set, but that the diameters (and the conical forms) of the working parts are correspondingly decreased.

Due to the increasing radii of the crowned portions of the working parts, an all in all slimmer shape of the respectively subsequent root canal instrument or its working part is obtained.

In order to ensure a gradual preparation, it is therefore especially advantageous if the diameter of the working part of the preceding root canal instrument at a smaller distance from the distal end of the working part is equal to the diameter of the working part of the subsequent root canal instrument at a larger distance from the distal end of its working part. This means that the root canal instruments at specified points each have the same diameter, these points of equal diameter having a different distance from the distal end of the working part such that the subsequent root canal instrument may be inserted deeper into the root canal until it reaches the portion of the root canal already processed by the preceding instrument. The result is that the conical portion of the root canal that has been processed by the preceding instrument is not or only very slightly processed again by the subsequent instrument. Thus, the necessary force contribution is considerably smaller. As a consequence, the friction is decreased, this in turn decreasing the load on the root canal instruments such that also the danger of breakage can be considerably reduced.

In order to obtain a standard processing or a standardized processing result, the invention provides that the cone angle or the diameter, respectively, of the last used instrument of the root canal instrument set is formed according to standards of the International Standards Organization (ISO).

In the aforementioned embodiment of the single radii or cone angles of the working parts and the effective lengths of the working parts, it is advantageous in a preferred further embodiment of the invention that the working part of the second canal root instrument and of each subsequent root canal instrument is formed with a sharpened cutting edge only in an area starting from the distal end of the working part. The portion being adjacent to the sharpened portion therefore should be preferably formed non-cutting. It may be formed such that it has only a scraping effect and leads to a further smoothing of the root canal. For the first root canal instrument, it is advantageous if it is sharpened over its whole length.

The diameter of the working part of the subsequent root canal instrument in the transitional area from the sharpened portion to the non-cutting portion is substantially equal to the diameter of the distal end of the working part of the preceding root canal instrument. Also in this way, a gradual processing of the root canals is ensured. In particular, it is prevented that the subsequent instrument has to be used to cut an unnecessarily large portion. The cutting portion is rather adjusted exactly to the lower part of the root canal to be processed.

It is especially advantageous if the collar of the respective root canal instrument is provided with a marking ring, preferably one that is raised. This enables the dentist or surgeon to monitor and control the penetration depth. The marking ring may for example be provided with a raised diameter, which is larger than the diameter of the collar. In this way, the flexibility of the root canal instrument due to the relatively thin collar is not disturbed.

The inventive root canal instruments can be manufactured from a variety of materials including stainless steel or a super elastic nickel-titan alloy. It is also possible to additionally provide them with a hard coating.

It is especially advantageous if the root canal instruments are formed as an integral part.

### BRIEF DESCRIPTION OF THE SEVERAL VIEWS OF THE DRAWING

The accompanying drawings, which are incorporated in and form a part of the specification, illustrate the embodiments of the present invention and together with the description, serve to explain the principles of the invention. In the figures, like parts are provided with like reference numerals. In the drawings:

FIG. 1 is a side view of a first embodiment of the inventive set of three root canal instruments,

FIG. 2 is an enlarged view of the respective working part of the instruments shown in FIG. 1,

FIG. 3 is a side view of a further alternative of the embodiment of a root canal instrument shown in FIG. 1 having marking rings,

FIG. 4 is a simplified cross-sectional view through the working parts of the three root canal instruments of FIG. 1 illustrating the different geometries of the cutting edges,

FIG. 5 is a side view of a second embodiment of the inventive set of three root canal instruments,

FIG. 6 is an enlarged view of the respective working parts of the instruments shown in FIG. 5,

FIG. 7 is a side view of a further alternative of the second embodiment of a root canal instrument shown in FIG. 5 having marking rings, and

FIG. 8 is a simplified cross-sectional view through the working parts of the three root canal instruments of FIG. 5 illustrating the different geometries of the cutting edges.

### DETAILED DESCRIPTION OF THE INVENTION

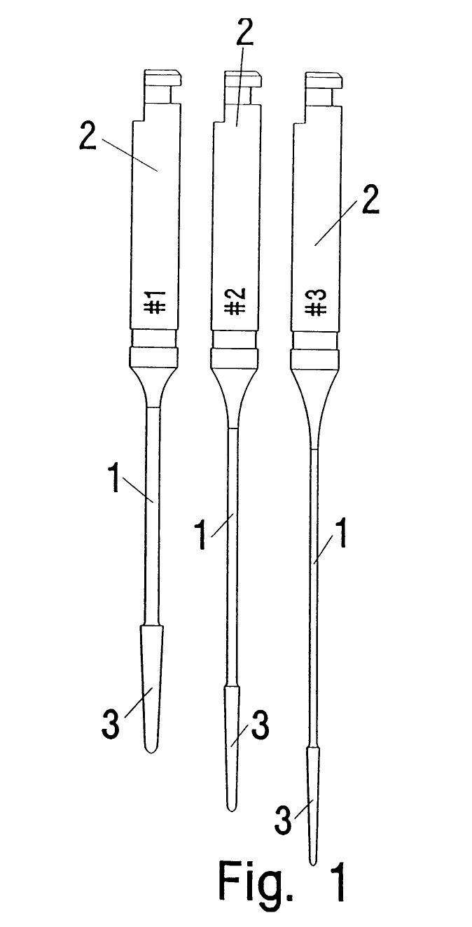

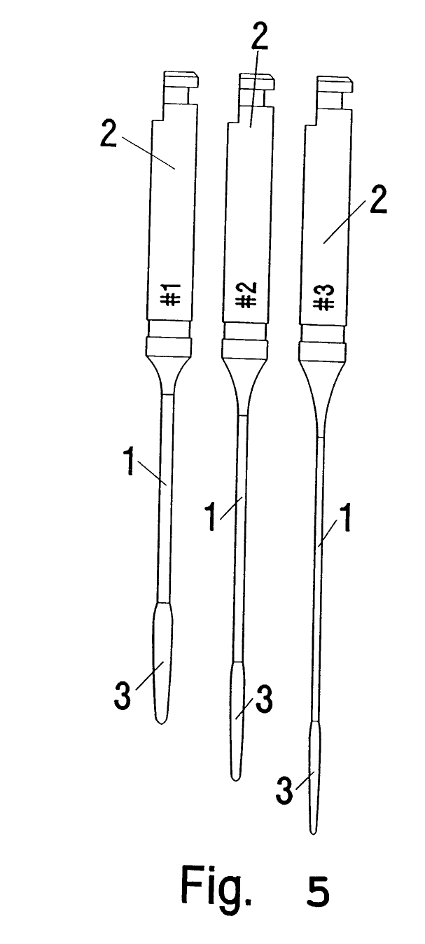

Each of the root canal instruments shown in FIGS. 1 and 5 shows a thin, elastic collar portion 1, the front end of which is provided with a working part 3 having a conical shape. The other end of the collar 1 is integrally connected to a shaft 2. The root canal instruments are suited to be used with a mechanical drive, the end of the shaft being formed accordingly. A detailed description is dispensed with, as the design is known from the state of the art.

The root canal instrument set is especially adapted to be used for apical root canal processing. Therefore, the maximum processing length of all used instruments is preferably approximately 12 mm. With respect to the crown-down technique to be used, the sizes or diameters, respectively, of the individual instruments decrease. According to the invention as shown, the set comprises three instruments of decreasing size. It is appreciated, however, that the set may comprise only two instruments or more than three instruments.

According to the invention, the working lengths of the individual instruments of the set may vary by 1 to 10 mm from each other. The working lengths result from the length of the working part 3 and the collar 1. The length of the working part 3 of the individual instruments may vary in a range of 3 to 10 mm.

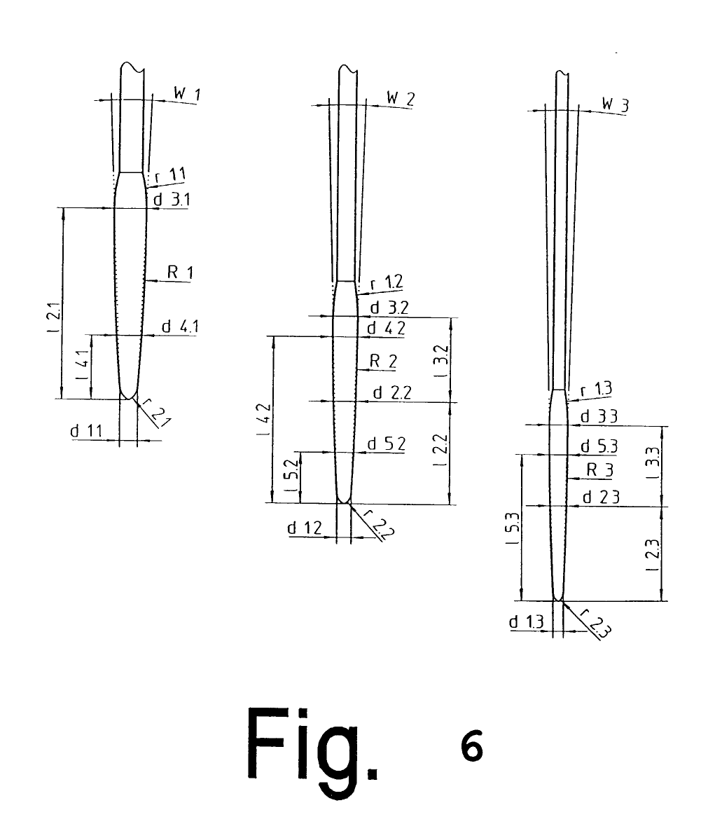

The opening angle of the cone of the first instrument (No. 1) for example ranges between 2° and 12°. As already described, the opening angle of each subsequent instrument is selected to be smaller. FIGS. 5-8 show inventive root canal instruments according to a second embodiment. In particular, the inventive root canal instruments have crowned or flame-shaped working parts 3. These show at their tips diameters d1.1, d1.2 and d1.3, which correspond to the standardized Internationalized Standard Organization (ISO) values. The front tip is normally formed not-cutting and serves as a guidance. It can be formed either as a frustrum or a hemisphere. In one embodiment, the radius of the front tip may be for example 0.445 mm for instrument No. 1, 0.325 mm for instrument No. 2 and 0.274 for instrument No. 3 (see radii r2.1, r2.2 and r2.3 in FIG. 6).

The crowned portions of the respective working parts 3 each have a radius of R1, R2 and R3. In one embodiment, these radii may be 62.6 for instrument No. 1, 83.4 for instrument No. 2 and 98.1 for instrument No. 3. The working part 3 being provided with the aforementioned radii merges into the collar 1 via a sloping portion or a portion having a radius of r1.1, 1.2 or 1.3. In one embodiment, said radii are 4.0 mm, 6.7 mm and 5.6 mm, respectively.

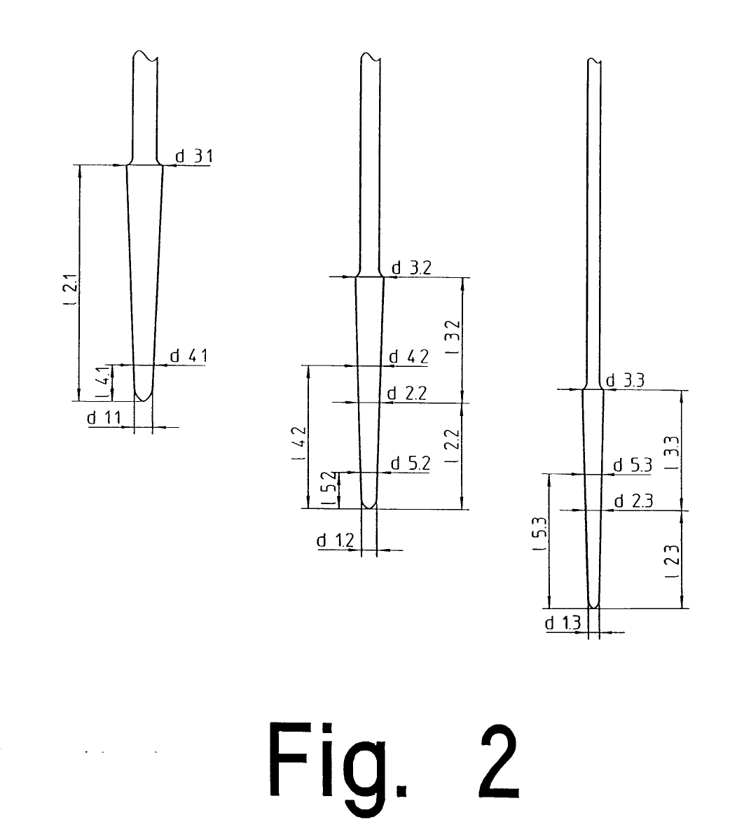

As shown in FIG. 6, the working part 3 has an eclipsed cone angle (theoretical angle) that is respectively measured at lines that have been placed at the tip diameters d1.1, d1.2 or d.1.3, respectively, as well as at the largest diameters d3.1, d3.2 and d3.3. This results in a theoretical angle of W1=4.58° for instrument No. 1, a theoretical angle of W2=3.32° for instrument No. 2 and a theoretical angle of W3=2.77° for instrument No. 3. As shown in the figures FIG. 2 and FIG. 6, this results in a decreasing diameter of the working part 3, such that the following equation is obtained:

d3.1>d3.2>d3.3,

the second digit of the diameter or the length designates the number of the used instrument.

In addition, an assignment of the sharp cutting portions of the working part 3 in relation to the non-cutting scraping portions of the working part is obtained, which is shown correspondingly in the figures. Therefrom, it results that

d1.1=d2.2

and

d1.2=d2.3.

Furthermore, the following assignment is obtained:

d4.1=d4.2

and

d5.2=d5.3.

The two first-mentioned equations give a hint to the assignment of the diameter in relation to the sharp cutting portion of the working part 3, whereas the two latter equations disclose the assignment of the diameter in relation to the opening angles of the cone or the crowned portions.

The first instrument is formed cutting throughout its complete length 12.1. For the two subsequent instruments, the sharp cutting portion is designated with 12.2 and 12.3, whereas the scraping portion is designated with 13.2 and 13.3.

Concerning the assignment of the opening angle and the given diameter, it is made clear in the figures that for the first instrument, a diameter d4.1 is provided at a distance 14.1 from the distal end, said diameter being equal to a diameter d4.2 of the second instrument at a distance 14.2 from its distal end. In the same manner, the second instrument has a diameter d5.2 at a distance 15.2 from the distal end, said diameter being equal to a diameter d5.3 of the third instrument at a distance 15.3 of its distal end.

As already mentioned, the working part 3 of the first instrument is sharpened throughout its complete length 12.1, whereas the sharp cutting portions of the instruments No. 2 and No. 3 are designated by the lengths 12.2 and 21.3, respectively. The lengths 13.2 and 13.3 are formed scrapingly. The diameters d2.2 and d2.3, at which the transition from the cutting portion to the scraping portion occurs, are each equal to the diameter at the distal end of the preceding instrument d1.1 and d1.2, respectively.

The litheness of all root canal instruments is ensured by the forming and dimensioning of the collar 1.

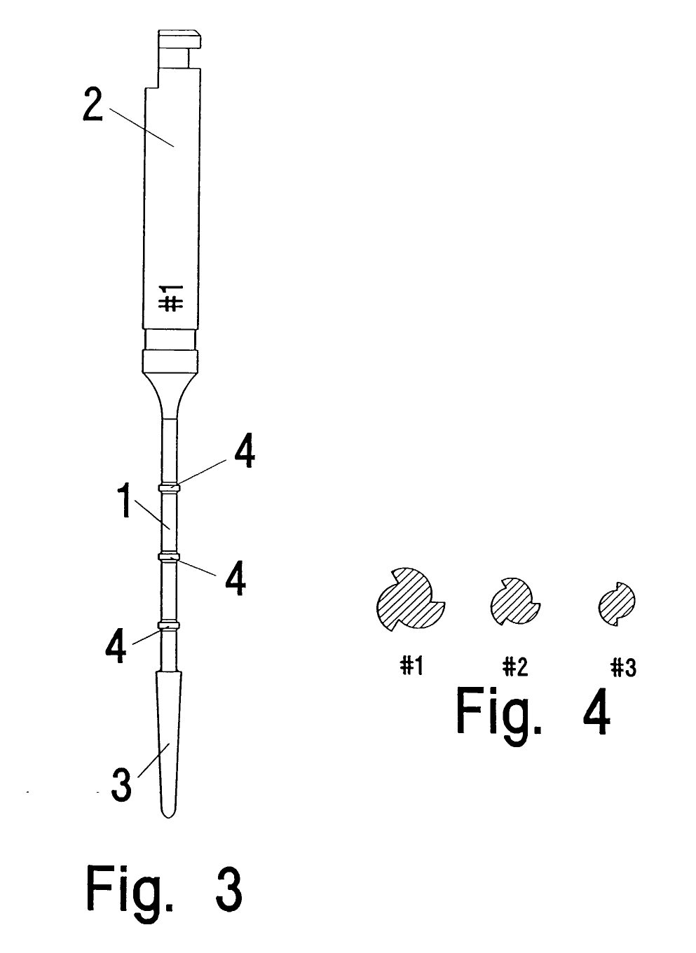

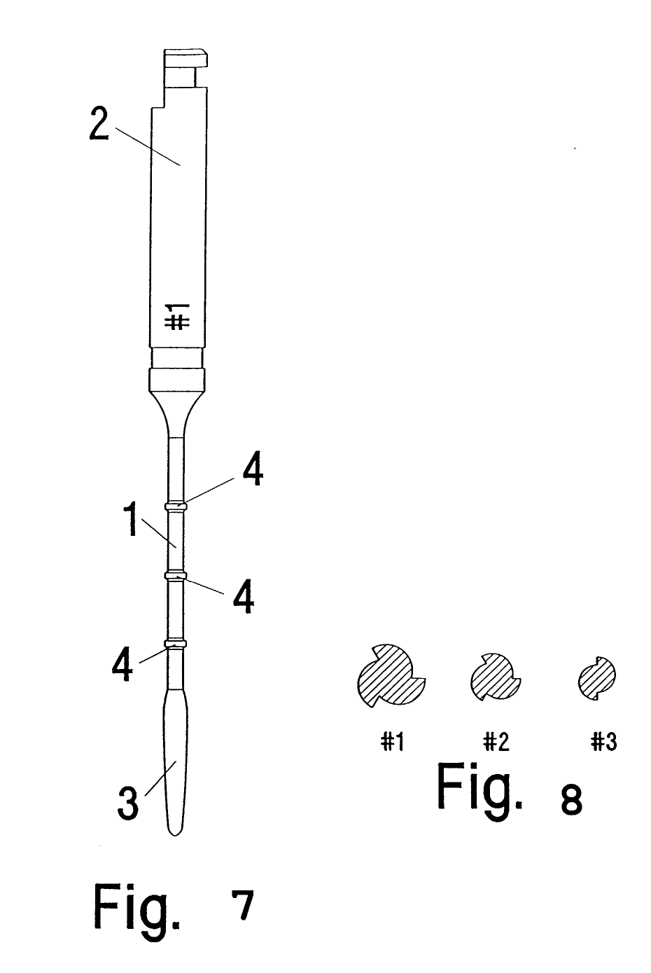

FIG. 3 and FIG. 7 show an embodiment in which raised marking rings 4 are provided to monitor the penetration depth. The marking rings do not impair the litheness of the collar 1.

FIG. 4 and FIG. 8 show three cross-sectional views of the cutting portion of the working part 3. It can be seen that the instruments No. 1 and No. 2 each comprise three cutting edges, whereas the instrument No. 3 is a two-edged instrument.

It is self-evident that the dimensions of individual sets as well as of the instruments of a set may be varied within the scope of the invention. Thus, sets having an overall larger working diameter as well as sets having an overall smaller diameter are possible.

According to the invention, it is also possible to combine the individual sets, such that these comprise crowned as well as conical instruments. In this way, it is possible to adapt the instruments particularly well to the most different working conditions and situations.

The invention is not limited to the illustrated embodiments; rather, many alterations and modifications are possible within the scope of the present invention. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

We claim:

1. A root canal instrument set comprising at least two root canal instruments, each root canal instrument having a diameter and being provided with a collar having a shaft end at one end, and a working part including at least one cutting edge on the other end, the working part being shaped conically and defining a cone angle which decreases from the preceding root canal instrument to the subsequent root canal instrument, the working part of the respectively preceding root canal instrument having a larger diameter than the working part of the respectively subsequent root canal instrument.

2. The root canal instrument set according to claim 1, wherein each working part has a working length, and the working length of the preceding root canal instrument is smaller than the working length of the subsequent root canal instrument.

3. The root canal instrument set according to claim 1 or 2, wherein the working part is conically interlocked.

4. The root canal instrument set according to claim 3, wherein the working part comprises at least one helical cutting edge.

5. The root canal instrument set according to one of claims 1 to 4, wherein each working part has a diameter, and the diameter of the working part of the preceding root canal instrument at a smaller distance from the distal end of the working part is equal to the diameter of the working part of the subsequent root canal instrument at a larger distance from the distal end of its working part.

6. The root canal instrument set according to one of claims 1 to 5, wherein the cone angle or the diameter, respectively, of the last used instrument is formed according to standards of the International Standard Organization.

7. The root canal instrument set according to one of claims 1 to 6, wherein the working part of the second root canal instrument and each subsequent root canal instrument has a sharpened cutting edge only in a portion starting from the distal end of the working part.

8. The root canal instrument set according to claim 7, wherein a portion being adjacent to the sharpened portion is formed non-cutting.

9. The root canal instrument set according to claim 8, wherein the non-cutting portion is formed scrapingly.

10. The root canal instrument set according to one of claims 7 to 9, wherein the working part of the first root canal instrument is sharpened throughout its complete length.

11. The root canal instrument set according to one of claims 7 to 10, wherein the diameter of the working part of each subsequent root canal instrument in a transitional area from the sharpened portion to the non-cutting portion is substantially equal to the diameter of the distal end of the working part of the preceding root canal instrument.

12. The root canal instrument set according to one of claims 1 to 11, wherein the collar is provided with at least one marking ring.

13. The root canal instrument set according to claim 12, wherein the marking ring has a diameter that is larger than the diameter of the collar.

14. The root canal instrument set according to one of claims 1 to 13, wherein the root canal instrument is formed integrally.

15. A root canal instrument set comprising at least two root canal instruments, each root canal instrument being provided with a collar having a shaft end at one end and a working part including at least one cutting edge on the other end, the working part being shaped crowned, such that the radii of the crowned working parts increase from the preceding root canal instrument to the subsequent root canal instrument, the working part of the respectively preceding root canal instrument having a larger diameter than the working part of the respectively subsequent root canal instrument.

16. The root canal instrument set according to claim 15, wherein each working part has a working length, and the working length of the preceding root canal instrument is smaller than the working length of the subsequent root canal instrument.

17. The root canal instrument set according to claim 15 or 16, wherein the working part is interlocked.

18. The root canal instrument set according to claim 17, wherein the working part comprises at least one helical cutting edge.

19. The root canal instrument set according to one of claims 15 to 18, wherein each working part has a diameter, and the diameter of the working part of the preceding root canal instrument at a smaller distance from the distal end of the working part is equal to the diameter of the working part of the subsequent root canal instrument at a larger distance from the distal end of its working part.

20. The root canal instrument set according to one of claims 15 to 19, wherein the working part of the second root canal instrument and each subsequent root canal instrument has a sharpened cutting edge only in a portion starting from the distal end of the working part (3).

21. The root canal instrument set according to claim 20, wherein the portion being adjacent to the sharpened portion is formed non-cuttingly.

22. The root canal instrument set according to claim 21, wherein the non-cutting portion is formed scrapingly.

23. The root canal instrument set according to one of claims 20 to 22, wherein the working part of the first root canal instrument is sharpened throughout its complete length.

24. The root canal instrument set according to one of claims 20 to 23, wherein the diameter of the working part of each subsequent root canal instrument in the transitional area from the sharpened portion to the non-cutting portion is substantially equal to the diameter of the distal end of the working part of the preceding root canal instrument.

25. The root canal instrument set according to one of claims 15 to 24, wherein the collar is provided with at least one marking ring.

26. The root canal instrument set according to claim 25, wherein the marking ring has a diameter that is larger than the diameter of the collar.

27. The root canal instrument set according to one of claims 15 to 26, wherein at least one of the root canal instruments is formed integrally.

28. The root canal instrument set according to one of claims 1 to 27, wherein the set comprises a combination of crowned and conical root canal instruments.
